(19) United States
(12) Patent Application Publication
(10) Pub. No.: US 2012/0154973 A1
(43) Pub. Date: Jun. 21, 2012

(54) BI-POLAR IONIZATION TUBE BASE AND TUBE SOCKET

(76) Inventors: Taisa VAYNERMAN, Marlton, NJ (US); Nikolay ORLOV, Cherry Hill, NJ (US); Stephen ZITIN, Bala Cynwyd, PA (US)

(21) Appl. No.: 13/351,893

(22) Filed: Jan. 17, 2012

Related U.S. Application Data
(63) Continuation of application No. PCT/US09/51998, filed on Jul. 28, 2009.
(60) Provisional application No. 61/083,999, filed on Jul. 28, 2008.

(51) Int. Cl. H01T 23/00

(52) U.S. Cl. 361/231

(57) ABSTRACT

The present invention provides an air treatment apparatus. The air treatment apparatus comprises a housing electrically connectable to a voltage source and generating a high voltage and a glass tube. The air treatment apparatus further comprises a tube base electrically connecting internally high voltage to an inner electrode within the glass tube and electrically connected internally an outer electrode surrounding the glass tube and a tube socket electrically connected internally to the outer electrode and electrically connected to a grounding pad, wherein the grounding pad is mechanically connectable to the housing and electrically connectable to the housing.

### CROSS-REFERENCE TO RELATED APPLICATIONS

This application is a continuation of International Application No. PCT/US2009/051998 filed on Jul. 28, 2009, which claims the benefit of U.S. Provisional Patent Application Ser. No. 61/083,999 filed on Jul. 28, 2008, the entireties of which are hereby incorporated herein by reference for all purposes.

### FIELD OF THE INVENTION

The present invention relates to a bi-polar ionization tube base and tube socket. The invention is comprised of a socket high voltage insert, ground spring insert and housing incorporates the tube socket assembly that attaches to the glass tube/wire mesh assembly. The ground spring and housing incorporates the tube base assembly. The connection of tube socket to tube base creates an electrical circuit to produce ionization thru the tube.

### DESCRIPTION OF BACKGROUND

Currently, bi-polar ionization represents a proven technology for the generation of an alternating current ionization field. Bioclimatic is a “Non-thermal Plasma Generator” which produces Bi-polar ionization of more than 100,000 ions per cc. in an approximate ratio of 5 positive ions to 4 negative ions.

Air ionization involves the reactions of electrically charged compounds: 1) recombination with other air ions; and 2) reaction with gaseous molecules. The Bi-polar ionization tube consists of two electrodes with one covering the outside surface of a glass tube and one on the inside surface. Through its alternating current, high voltage output an ionization field is generated around the tube. When air with gaseous compounds passes through the field, they will react with covalent compounds like O₂⁺ and hydroxyl ions (OH⁻) to form less objectionable, odorless compounds like CO₂ and H₂O. Acrolein, Ammonia, Acetaldehyde, Formaldehyde are examples of compounds generated by tobacco smoke and controlled with Bi-polar Ionization.

Microbial contaminants (mold, fungal spores, and bacteria) are controlled by exposure of the microbe to the ionization field, which will, after a suitable exposure alter the DNA and render the microbe ineffective. The mechanism is identical that of UV light although the reduction efficiency is much lower compared to UV.

Static electricity, a natural occurrence in closed building and a by-product of burning a cigarette, causes microscopic particles to be attracted to building surfaces, furnishings and occupants through an electrostatic attraction to a grounded surface. When the airborne static charges are reduced there is a greater probability that airborne particles will be returned to the air handler to be filtered from the air stream.

FIG. 1 depicts a generic air ionization device 7 to condition air. Device 7 includes a housing 11 that typically has at least one air ionization glass tube 13 connected through base 12. The air ionization glass tube 13 is surrounded by an outer electrode array 15 is grounded through an exposed grounding strap 19. Within the glass tube 13 there is disposed an electrode assembly comprising a second inner electrode array (not shown). Device 7 further includes a high voltage generator (not shown) coupled between the first and second electrodes. An advantage of electro-kinetic devices such as device 7 is that an airflow is created without using fans or other moving parts.

Preferably particulate matter in the ambient air can be electrostatically attracted to the elderly electrode array 15, with the result that the outflow (OUT) of air from device 7 not only contains ozone and ionized air, but can be cleaner than the ambient air. In such air ionization devices, it can become necessary to occasionally clean the second outer electrode array 15 to remove particulate matter and other debris from the surface.

Accordingly, a person must remove the outer electrical array 15 from glass tube 13. In doing so, the exposed grounding strap 19 present a shock hazard should the person forget to power down the unit when they tried to remove the outer electrical array 15 from the glass tube 13.

### SUMMARY OF THE INVENTION

In example embodiments, the present invention provides an air treatment apparatus.

In one aspect, air treatment apparatus comprises a housing electrically connectable to a voltage source and generating a high voltage and a glass tube. The air treatment apparatus further comprises a tube base electrically connecting internally high voltage to an inner electrode within the glass tube and electrically connected internally an outer electrode surrounding the glass tube and a tube socket electrically connected internally to the outer electrode and electrically connected to a grounding pad, wherein the grounding pad is mechanically connectable to the housing and electrically connectable to the housing.

In another aspect, the invention provides a tube base for an air treatment apparatus. Tube base comprises a first internally electrical link connectable to an inner electrode within a glass tube, and a second internally electrical link connectable to an outer electrode surrounding the glass tube. The tube base further comprises an o-ring shoulder for supporting an O-ring between the tube base and a glass tube to prevent moisture penetration.

These and other aspects, features and advantages of the invention will be understood with reference to the drawing figure and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a generic air ionization device 7 that outputs ionized air and ozone, according to the prior art.

FIG. 2 shows a side view of the bi-polar ionization device with tube base and socket assembly that eliminates the external contact of the present invention.

FIG. 3 is a cutaway side view of the bi-polar ionization device according to an electrical embodiment of the bi-polar ionization device of the present invention.

FIG. 4 is a cutaway side view according to an example embodiment of the bi-polar ionization device 10 of the present invention.

FIG. 5 is another cutaway side view according to an example embodiment of the bi-polar ionization device of the present invention.

FIG. 6 is a cutaway side view of the separate base and socket assembly according to an example embodiment of the present invention.

FIG. 7 is a perspective view of the separate components for the tube base according to an example embodiment of the present invention.

FIG. 8 is a perspective view of the separate components for the socket assembly according to an example embodiment of the present invention.

FIG. 9 is a top view of the outer electrode over the glass tube.

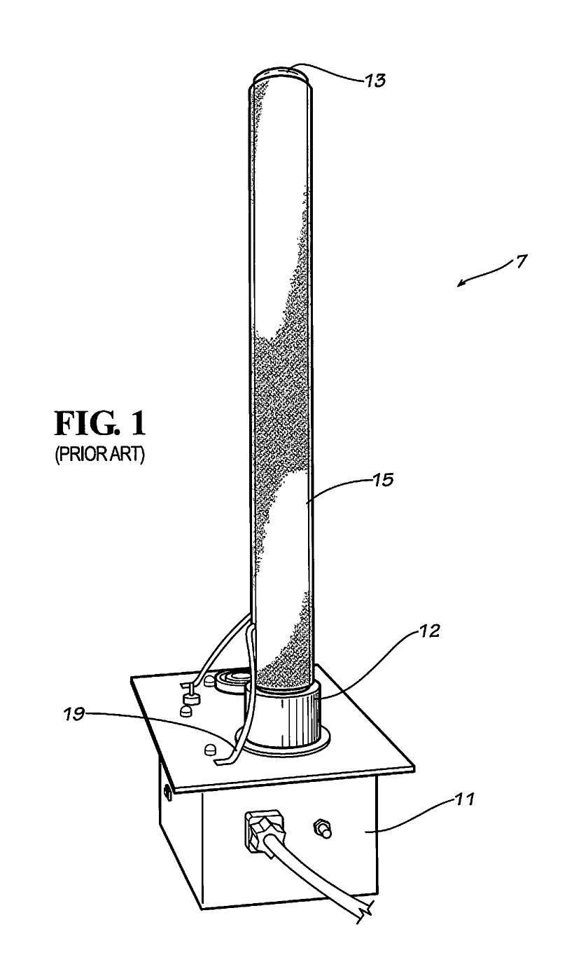

The detailed description explains the preferred embodiments of the invention, together with advantages and features, by way of example with reference to the drawings.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The present invention incorporates within the ion tube base and socket, internal electrical connections for both load and ground to support 4500 volts. A unique grounding pad at an attaching point permits the ion tube to be installed with one hand and eliminates the need for an external ground contact. A beveled receiver of the tube base seals the ion tube base and the tube socket so that water vapor will not penetrate the interstitial surfaces and cause arcing. This enables the bi-polar ionization device with tube base and socket assembly to operate at a high frequency to provide 3 times the output of current models that operate at 50/60 Hz.

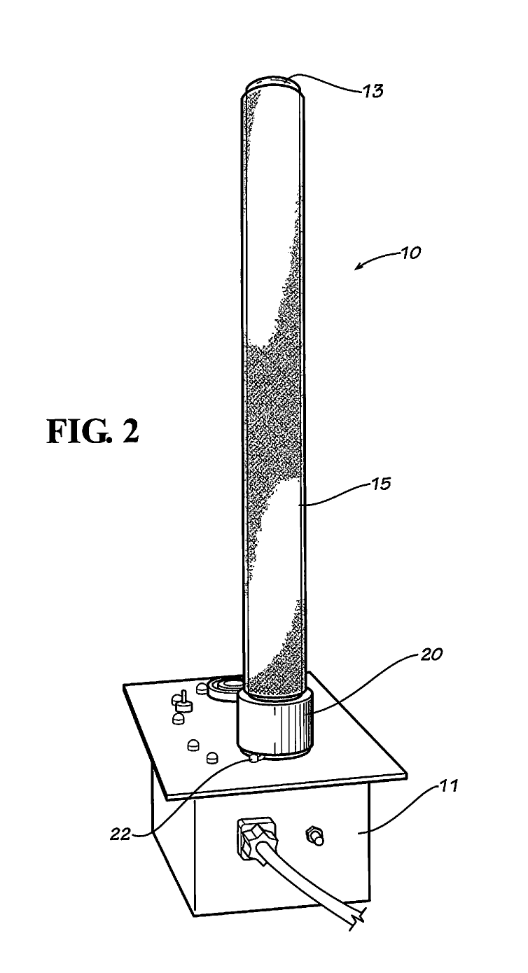

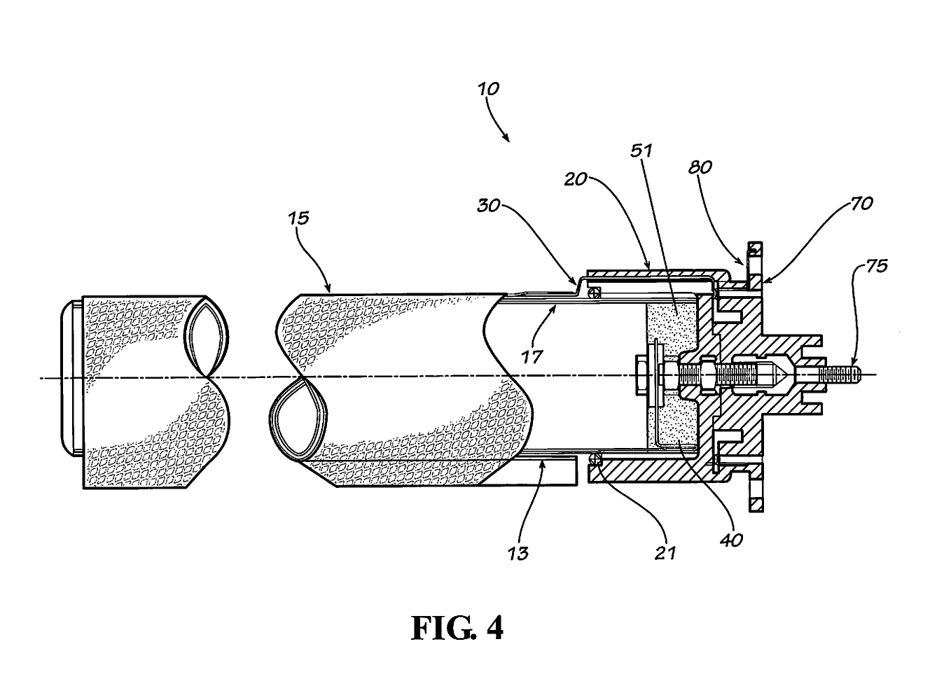

With reference now to the drawing figures, wherein like reference numbers represent corresponding parts throughout the several views, FIG. 2 shows a side view of the bi-polar ionization device 10 of the present invention with tube base 20 and tube socket 70 assembly, that eliminates the external contact. As shown, bi-polar ionization device 10 includes a housing 11 that has at least one air ionization glass tube 13 connected through tube base 20. The air ionization glass tube 13 is surrounded by an outer electrode 15 and is grounded through a non-exposed grounding pad (not shown). As shown, the tube base 20 and tube socket 70 assembly is connected to housing 11 by anchor screws 22. The anchor screws 22 connected with the non-exposed grounding pad to ground the bi-polar ionization device 10. Inclusion of the non-exposed grounding pad prevents shock hazards. A non-exposed grounding pad is herein defined in further detail with regard to FIGS. 4, 6, and 9.

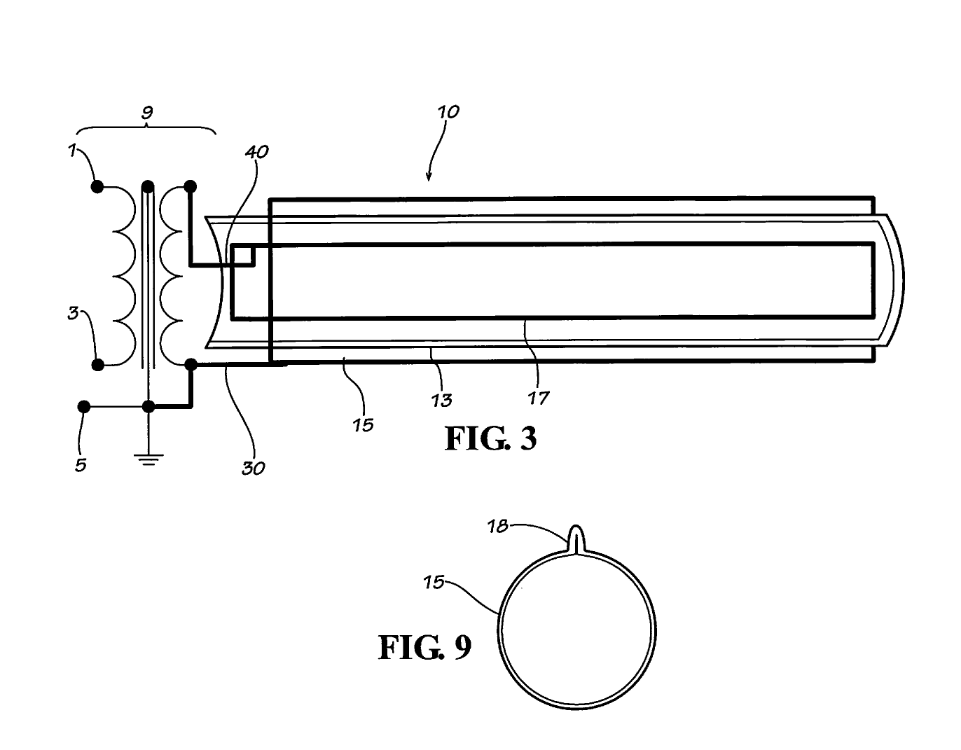

FIG. 3 is a side view of the bi-polar ionization device 10 according to an electrical embodiment of the bi-polar ionization device of the present invention. As shown, the air ionization glass tube 13 contains a inner electrode 17 that is connected to power strip 40. The power strip 40 is being connected to the high-voltage side of a transformer coil 9. In the preferred embodiment the high-voltage ranges from 2000 to 3000 V. The transformer coil 9 is connected to the standard electrical service of 120 or 220 V. The electrical service includes the load 1, neutral 3 and ground 5 terminals. The when the bi-polar ionization device 10 is energized, the high-voltage flows through the power strip 40, the inner electrode 17 produces ions. These ions are attracted to the outer electrode 15. The outflow of these ions to outer electrode 15 causes particulate matter to neutralize any electrical charge on the particulate matter. This prevents the particulate matter from adhering building surfaces or occupants. In the process of generating the ionized airflow appropriate amounts of ozone (O.sub.3) are beneficially produced. The ions flow causes current flow to ground spring 30 which is connected to transformer coil 9 and to ground 5.

FIG. 4 is a cutaway side view according to an example embodiment of the bi-polar ionization device 10 of the present invention with the tube base 20 and tube socket 70 connected. In this embodiment of the bi-polar ionization device 10, the bi-polar ionization device 10 includes the air ionization glass tube 13 with the inner electrode 17 and outer electrode 15 as discussed previously. As now shown, the bi-polar ionization device 10 shows a cutaway view of tube base 20 and tube socket 70. It is tube base 20 and tube socket 70 that provides the inventive features of the bi-polar ionization device 10 of the present invention. As shown in the high voltage enters the bi-polar ionization device 10 through high-voltage connector 75 that is connected to power strip 40. Power strip 40 is in connected to the inner electrode 17 within the air ionization glass tube 13. Ground connections for the bi-polar ionization device 10 is through ground connection 80 on the tube socket 70.

Included in the tube base 20 is an O-ring 21. The O-ring 21 seals the air ionization glass tube 13 to tube base 20, so that water vapor will not penetrate the interstitial surfaces that can cause arcing. In the preferred embodiment, the o-ring comprises a silicon material.

Also shown in the cutaway of tube base 20 is the bonding material 51. It is the bonding material that further provides a seal that water vapor will not penetrate. The bonding material 51 covers the power strip 40 that connects to inner electrode 17. In operation, the glass tube is slid into the tube base 20 so that the inner electrode 17 comes in contact with the power strip 40 and is sealed on the inside by bonding material 51. In this way, the O-ring 21 prevents water vapor from entering from outside of the air ionization glass tube 13 and bonding material 51 prevents any water vapor from coming in contact with the power strip.

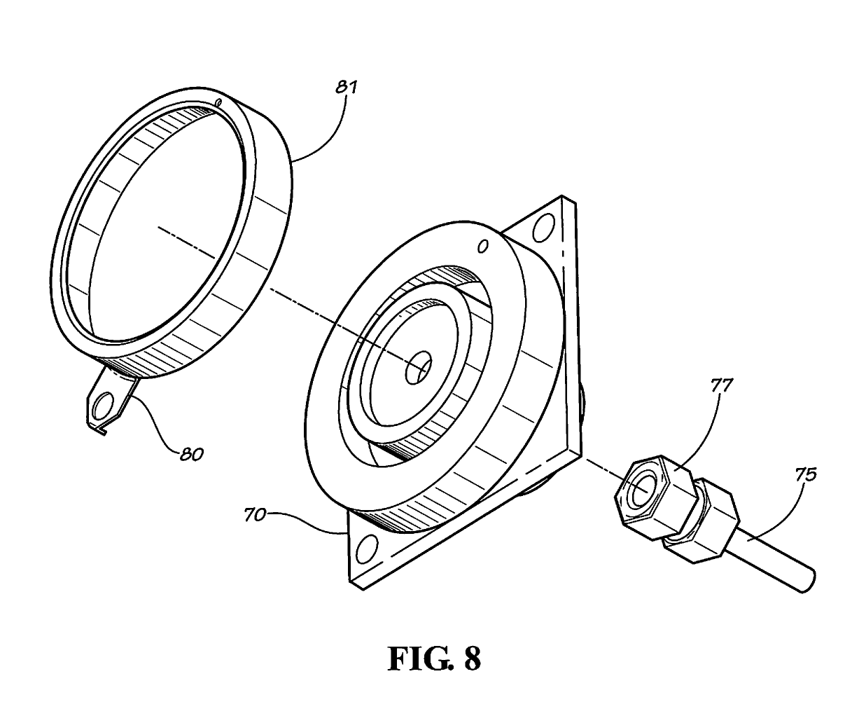

Also shown in FIG. 4 is the tube socket 70 with the ground connection 80. The ground connection 80 is connected through grounding collar 81 molded into the tube socket 70. The grounding collar 81 is herein defined in further detail with regard to FIG. 8. The ground connection 80 is a exposed electrical ground that is covered by the grounding screw that secures the tube socket to the housing 11 (FIG. 2)

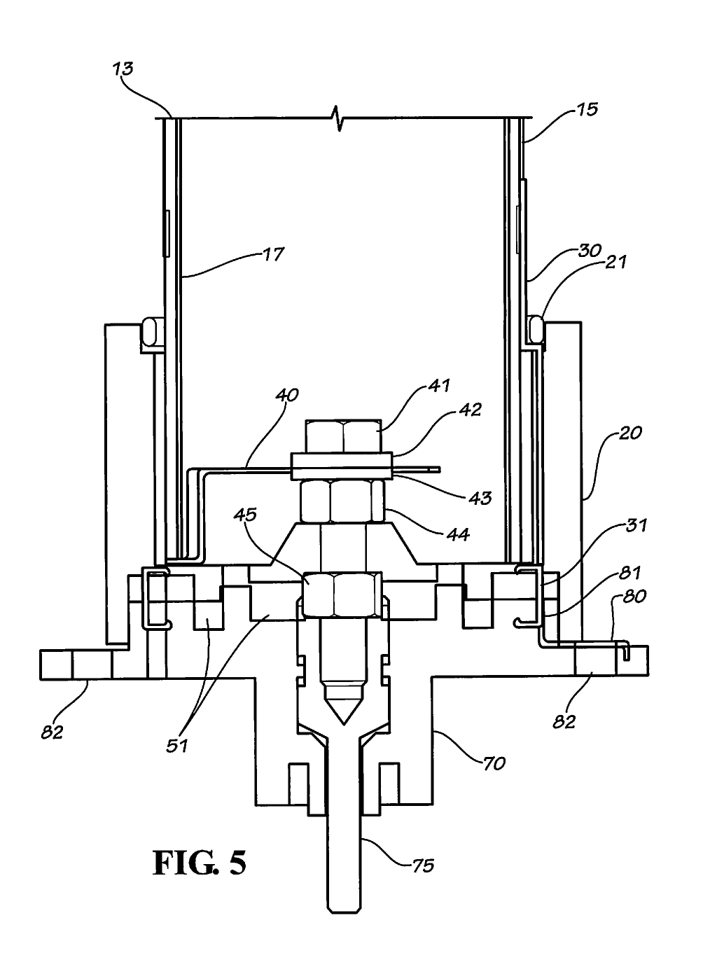

FIG. 5 is another side view according to a example embodiment of the bi-polar ionization device 10 of the present invention. Shown is the bi-polar ionization device 10 of the present invention with the tube base 20 and tube socket 70 connected. In this example of the bi-polar ionization device 10, the air ionization glass tube 13 with the inner electrode 17 and outer electrode 15 are shown as discussed previously.

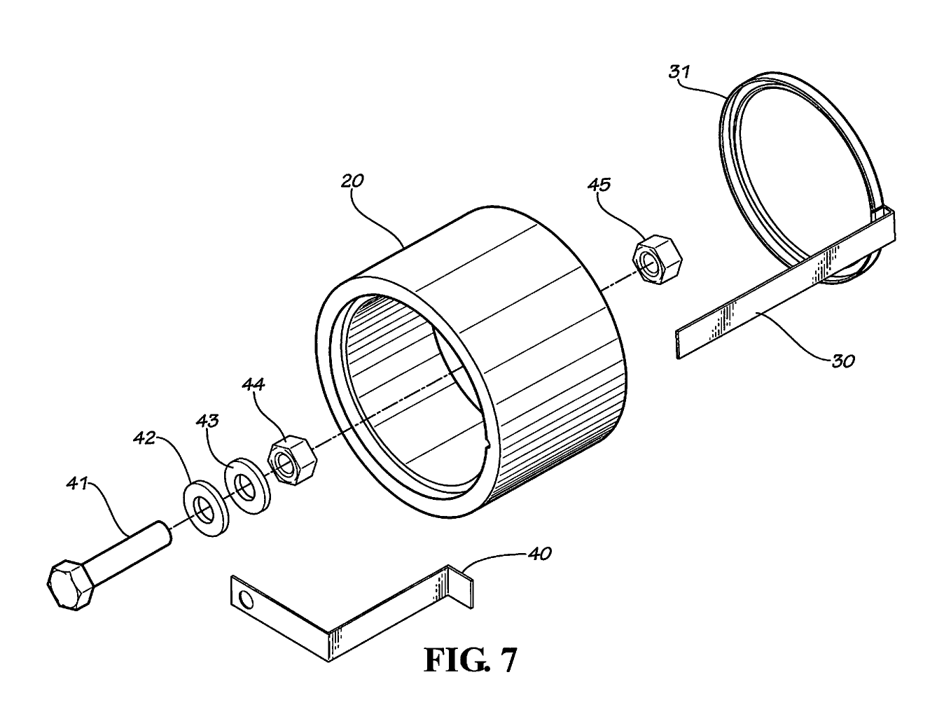

As now shown, the bi-polar ionization device 10 includes power strip 40 connected between a power connection assembly comprising of washers 42 and 43 with hex nuts 41 and 44 on either side. The power assembly is shown herein in further detail with regard to FIG. 7. The power strip and assembly is electrically connected to the high-voltage connector 75 in the tube socket 70. Also shown is the bonding material 51 between the tube base 20 and tube socket 70 assembly.

Also shown is the grounding spring 30 connected to the grounding collar 31. The grounding collar 31 is within the tube base 20. The tube base 20 is constructed by utilizing injection molding material around grounding collar 31. This non-electrical conductive material includes, but is not limited to, Makrolon 9415®, or the like. Grounding collar 31 within tube base 20, is electrically connected to the grounding collar 81 in the tube socket 70. The grounding collar 31 and grounding collar 81 are electrically isolated from power strip 40 and assembly 41-45 and tube base 30 and tube socket 70.

Also shown in FIG. 5 is the ground connection 80 on tube socket 70. The ground connection 80 surrounds screw slot 82. When they screw it 22 anchors the bi-polar ionization device 10 to housing 11, the ground connection 80 is removed from exposure to a person.

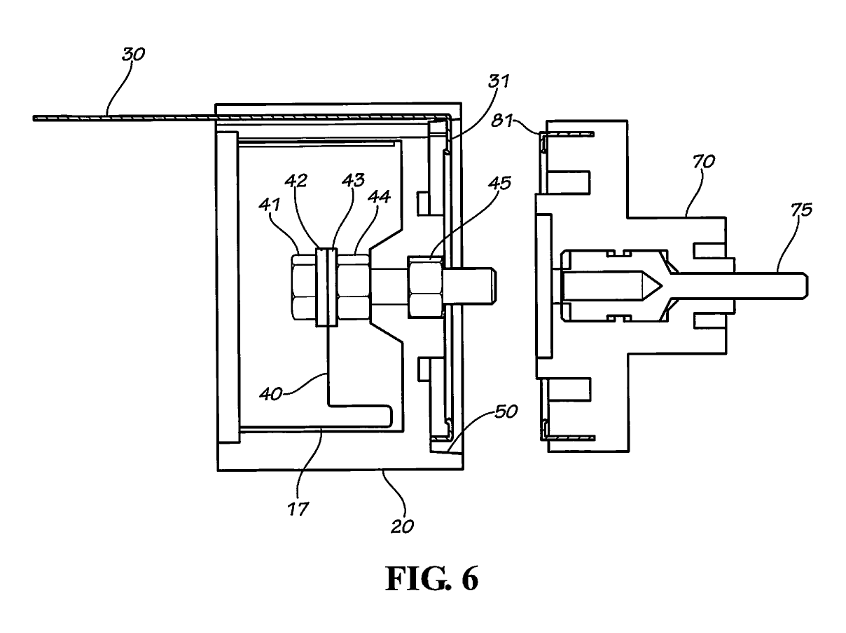

FIG. 6 is a side view of the separate tube base 20 and tube socket 70 assembly according to an example embodiment of the present invention. FIG. 6 gives an example illustration of how the tube base 20 and tube socket 70 are connected. As shown power strip 40 and power assembly 41-45 in the tube base 20 provide a connection to the high-voltage connector 75 in the tube socket 70 assembly. Also shown is how the grounding spring 30 and the grounding collar 31 is molded in tube base 20. Also illustrated is how grounding collar 81 is molded into the tube socket 70. Illustrated is that when the tube base 20 and tube socket 70 are connected then grounding collar 31 and grounding collar 81 are electrically connected as well.

In an alternative embodiment, assembly receiver 50 in tube base 20 is beveled or chamfered, so as to provide a watertight seal when the tube socket 70 assembly is connected to the tube base 20. The tighter the tube socket 70 assembly is pressed upon tube base 20, the tighter the watertight seal. The beveling is within the range of between 45 and 90°, and in the preferred embodiment, the beveling is in the range of approximately 75-89°.

FIG. 7 is a perspective view of the separate components for the tube base 20 according to an example embodiment of the present invention. The components of tube base 20 include the ground spring 30 electrically connected to grounding collar 31. Also included are the power strip 40 and power components 41-45, electrically connected to the high-voltage connector 75. In the preferred embodiment, the grounding collar 31 has the tube base 20 injection molded to it. The power strip 40 and power assembly 41-45 are then connected to tube base 20 after the injection molding cools. An alternative embodiment, the tube base 20 can be manufactured by means other than injection molding and then have grounding collar 31 adhered to tube base 20 utilizing a bonding material or heat.

FIG. 8 is a perspective view of the separate components for the tube socket 70 assembly according to an example embodiment of the present invention. As shown, grounding collar 81 is electrically connected to the exposed ground connection 80. When the tube socket 70 assembly is mechanically connected to housing 11 (FIG. 2) by screw 22, then screw 22 provides the electrical grounding of the bi-polar ionization device 10. In the preferred embodiment, grounding collar 81 and ground connection 80 are connected to tube socket 70, when tube socket 70 is injection molded around grounding collar 81. The high-voltage connector 75 and hex nut 77 is also embedded in the tube socket 70 during the injection molding. An alternative embodiment, the tube socket 70 can be manufactured by means other than injection molding and then have grounding collar 81 adhered to tube socket 70 utilizing a bonding material or heat.

FIG. 9 is a top view of the outer electrode 15 over the air ionization glass tube 13. The outer electrode slips over the air ionization glass tube 13 loosely. A loop is compressed in the outer electrode along the entire length of the glass tube. The loop is compressed to adjust the tension of the external electrode on the glass tube surface. This provides the ability to set the capacitance within the prescribed limits by adjusting the tension. As the loop is being compressed, the capacitance is measured by a multimeter (not shown). The prescribed limits are measured at 24° C., 45-50% relative humidity and the capacitance in the range of 1.4 to 2.4 nF±20%

While the invention has been described with reference to preferred and example embodiments, it will be understood by those skilled in the art that a variety of modifications, additions and deletions are within the scope of the invention, as defined by the following claims.

What is claimed is:

1. An air treatment apparatus, comprising:
a housing electrically connectable to a voltage source and generating a high voltage;
a glass tube;
a tube base electrically connectable internally a high voltage to an inner electrode within the glass tube and electrically connected internally to an outer electrode surrounding the glass tube;
a tube socket electrically connectable internally to the outer electrode and electrically connectable to a ground pad, wherein the ground pad is mechanically connectable to the housing and electrically connectable to the housing.

2. The air treatment apparatus of claim 1, wherein the grounding pad uses a screw to mechanically attach the tube socket to the housing and electrically connect the tube socket to the housing.

3. The air treatment apparatus of claim 1, wherein the tube base is electrically connected to the outer electrode using a ground spring.

4. The air treatment apparatus of claim 3, wherein shock hazard is eliminated in event of a broken ground spring.

5. The air treatment apparatus of claim 1, wherein the tube base further comprises a means to seal the tube base to the tube socket to prevent moisture penetration.

6. The air treatment apparatus of claim 5, wherein the means to seal the tube base to the tube socket is a beveled receptacle on the tube base to receive the tube socket.

7. The air treatment apparatus of claim 1, wherein the tube base overlaps the tube socket to provide structural strength.

8. The air treatment apparatus of claim 1, wherein the tube base overlaps the tube socket to provide a means to isolate the high voltage and ground contacts in the tube socket and the tube base by overlapping mating surface of electrical contacts.

9. The air treatment apparatus of claim 8, wherein the overlapping of the surface of the electrical contacts provides an electrical insulation between tube socket and tube base up to 4,500 Volts.

10. The air treatment apparatus of claim 1, wherein capacitance of the outer electrode surrounding the glass tube was set within a pre-subscribe limits by adjusting a tension of the external electrode on the glass tube.

11. A tube base for an air treatment apparatus, comprising:
a first electrically internally link connectable to an inner electrode within a glass tube;
a second electrically internally link connectable to an outer electrode surrounding the glass tube; and
an o-ring shoulder for supporting an O-ring between the tube base and a glass tube to prevent moisture penetration.
